(19) United States
(12) Patent Application Publication
(10) Pub. No.: US 2017/0017212 A1
(43) Pub. Date: Jan. 19, 2017

(54) ADAPTIVE NONLINEAR MODEL PREDICTIVE CONTROL USING A NEURAL NETWORK AND INPUT SAMPLING

(71) Applicant: The Florida State University Research Foundation,, Tallahassee, FL (US)

(72) Inventors: Emmanuel Collins, Tallahassee, FL (US); Brandon Reese, Tallahassee, FL (US); Damion Dunlap, Panama City Beach, FL (US)

(21) Appl. No.: 15/278,990

(22) Filed: Sep. 28, 2016

Related U.S. Application Data
(63) Continuation of application No. PCT/US2015/027319, filed on Apr. 23, 2015.
(60) Provisional application No. 61/983,224, filed on Apr. 23, 2014.

(51) Int. Cl. G05B 13/02; G06N 3/04; G06N 3/08

(52) U.S. Cl. CPC G05B 13/027; G06N 3/084; G06N 3/0436; G05B 2219/33039

(57) ABSTRACT

A novel method for adaptive Nonlinear Model Predictive Control (NMPC) of multiple input, multiple output (MIMO) systems, called Sampling Based Model Predictive Control (SBMPC) that has the ability to enforce hard constraints on the system inputs and states. However, unlike other NMPC methods, it does not rely on linearizing the system or gradient based optimization. Instead, it discretizes the input space to the model via pseudo-random sampling and feeds the sampled inputs through the nonlinear plant, hence producing a graph for which an optimal path can be found using an efficient graph search method.

### CROSS-REFERENCE TO RELATED APPLICATIONS

This nonprovisional application is a continuation of and claims priority to International Patent Application No. PCT/US2015/027319, entitled “ADAPTIVE NONLINEAR MODEL PREDICTIVE CONTROL USING A NEURAL NETWORK AND INPUT SAMPLING”, filed Apr. 23, 2015 by the same inventors, which claims priority to provisional U.S. Patent Application Ser. No. 61/983,224 filed on Apr. 23, 2014, titled, “ADAPTIVE NONLINEAR MODEL PREDICTIVE CONTROL USING A NEURAL NETWORK AND INPUT SAMPLING,” which is hereby incorporated by reference in its entirety.

### FEDERALLY SPONSORED RESEARCH OR DEVELOPMENT

This invention was made with Government support under Contract No. CMMI-1130286 awarded by the National Science Foundation, and Contract No. W911NF-13-1-0122 awarded by the Army Research Office. The government has certain rights in the invention.

### BACKGROUND OF THE INVENTION

Model Predictive Control (MPC) is widely used in industry over a range of applications differing in time scale and model complexity. MPC operates by producing a future sequence of control inputs and the corresponding output trajectory that optimizes a cost function, requiring an internal model that represents the system to be controlled. Receding horizon MPC approaches use this model to predict several steps in the future while implementing only the immediate next step.

Although most MPC implementations use linear models, nonlinear models allow for better performance over a wider operating range. Furthermore, adaptive Nonlinear MPC (NMPC) provides the additional benefit of enabling the model to be updated as plant dynamics change.

Constraints on inputs and outputs may be appropriate in order to maintain feasible trajectories, ensure safe operating levels, or regulate environmental pollutants. Industry demand for handling hard constraints has steadily increased, and MPC is among the few control techniques that are suitable to handle these constraints.

The Generalized Predictive Control (GPC) method was the first to merge adaptive control techniques with MPC. GPC handles plants with changing dynamics by using an adaptive linear model and performs well despite unknown time delays, which is an advantage of MPC approaches. One particular disadvantage of GPC over other MPC methods is that there is no guarantee that hard input and output constraints will be met. Although Clarke mentions the potential of modification to handle constraints, neither the original GPC nor any of the nonlinear GPC extensions mentioned below guarantee constraint satisfaction.

When implementing MPC, the model that is used for prediction is obtained in one of several ways. While it is known in the art to take the model to be specified a priori, it is often practical to perform system identification and fit a model from observed input output behavior. The neural network pattern recognition paradigm is useful for representing general nonlinear system behavior, which is done by using computational building blocks called hidden units or neurons. It is possible to capture nonlinear system behavior by training and updating a neural network to predict the future response of the system based on past observations.

GPC has been extended to nonlinear systems using neural network models. The Neural GPC algorithm enables control of a single input single output (SISO) plant, wherein it uses a network with fixed parameters after the learning phase ends and hence is not an adaptive control algorithm. The Neural GPC algorithm has been applied experimentally to a SISO nonlinear magnetic levitation system using a network with only three computational units in the hidden layer. Another neural-network-based NMPC approach called Explicit Black Box NMPC was recently introduced but is also a SISO result that does not utilize the adaptive capability of a neural network model. Adaptive Predictive Control performs NMPC using neural networks for both identification and control. Like the other neural network results, the plant controlled by this method is SISO.

NMPC has also been applied to nonlinear systems identified without the use of neural networks. Fuzzy GPC is applied to the SISO, nonlinear, simple inverted pendulum, and an adaptive Fuzzy GPC implementation that controls a nonlinear time-varying SISO plant has also been presented in the prior art. In each case, the methods based on nonlinear Fuzzy models are described as computationally costly. This is due to the intensive computational effort required to solve Diophantine equations required in the GPC optimization.

When controlling a combustion system, constraints on inputs and outputs are necessary in order to meet power demands, ensure safe operating levels, or regulate environmental pollutants. For these reasons, the industry's need for handling these constraints has steadily increased, and MPC is arguably the control methodology most suitable to handle them. MPC uses an internal model that represents the system to be controlled, and produces a future sequence of control inputs and the corresponding output trajectory that optimizes a cost function, subject to constraints on functions of the inputs and outputs. Receding horizon MPC approaches use this model to predict several steps in the future while implementing only the immediate next step.

MPC is commonly applied in simulations to power plants, and, for applications where no closed-form model is available, is typically applied in conjunction with an identified system model. Linear MPC techniques often use a Least-Squares, Gradient Descent, or Newton method to fit a linear model to observed data. Nonlinear MPC techniques, which are far less commonly used, often fit a Neural Network, Neuro-Fuzzy, Nonlinear Polynomial, or other Nonlinear State Space model to predict system behavior.

Due to environmental effects, normal wear, and fatigue, power plant combustion chambers can exhibit time-dependent dynamic behavior. Furthermore, the addition of solar and wind power plants, which provide intermittent power to the grid, has caused the duty cycle of traditional power plants to fluctuate more than ever before. The neural network model form is suitable for modeling the nonlinearities and time variation, which lead to suboptimal performance when they are ignored. The Neural Generalized Predictive Control (Neural GPC) method consists of a Back Propagation Neural Network (BPN) and Newton-Raphson cost optimization. It is best able to handle problems with nonlinearities and time variation among existing NMPC methods because it balances speed of optimization with adaptive capability.

An analytical model for coal combustion has been derived in the prior art. This model has been used in a Single-Input Single-Output (SISO) simulation of Gaussian Process NMPC, which requires a priori specification of the plant's dynamic equations and achieves rapid online computational speed, at the expense of significant offline computation and a lack of robustness to plant changes.

Accordingly, what is needed is a novel method for adaptive NMPC of multiple input, multiple output (MIMO) systems that has the ability to enforce hard constraints on the system inputs and states, but does not rely on linearizing the system or gradient based optimization. However, in view of the art considered as a whole at the time the present invention was made, it was not obvious to those of ordinary skill in the field of this invention how the shortcomings of the prior art could be overcome.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### BRIEF DESCRIPTION OF THE DRAWINGS

For a fuller understanding of the invention, reference should be made to the following detailed description, taken in connection with the accompanying drawings, in which:

FIG. 1 is a schematic diagram of adaptive sampling based model predictive control. The control task is to provide inputs u to the plant such that outputs y match a reference trajectory. The neural network model is identified online and provides the prediction information needed by SBMPC to perform the MPC optimization.

FIG. 2 is a flowchart of a minimal resource allocation network. The MRAN algorithm learns the number of hidden units needed to represent the system and continually refines the parameters of each hidden unit.

FIG. 3 is a schematic diagram of a sampling based model predictive control summary. The algorithm discretizes the input space and makes model-based state predictions. \hat{x}ₖ₊ⱼ, in order to minimize a cost function.

FIG. 4 is a sampling based model predictive control graph. The graph is built by expanding the most promising node to generate B child nodes. Each child node is assigned an input sample, which is propagated forward through the model to predict a state for that node. The potential cost of reaching that state is used to prioritize the nodes and select the most promising candidate for the next iteration of expansion.

FIG. 5 is a graph depicting a Single Output Neural Network ID comparison. Each neural network is trained with sequential input and output data during the training phase. Prediction error is based only on prediction of x_{O2}.

FIG. 6 is a graph depicting a Multiple Output Neural Network ID comparison. Identification error is computed based on predictions for the three outputs, x_{O2}, x_{CO}, x_{CO2}. For this case, the BPN adaptation converges more slowly, but two identification methods eventually attain comparable prediction error.

FIG. 7A presents the results for Neural GPC.

FIG. 7B presents the results for SBMPC_{RBF}.

FIG. 7C presents the results for SBMPC_{BPN}.

FIG. 8 presents the Neural GPC Case 2 results. Penalties on CO and CO₂ are introduced and Inputs, O₂ tracking, and CO₂ levels are plotted. The shaded upper and lower regions on the input plots are infeasible regions beyond the input constraints. The value u_{2,SAT} is input to the plant when the fuel rate constraint violation occurs. Because of this saturation of u₂, tracking performance is poor as u₁ alone lacks the control authority to track the reference.

FIG. 9 presents the SBMPC_{RBF} Case 2 results. Penalties on CO and CO₂ are introduced and Inputs, O₂ tracking, and CO₂ levels are plotted. The shaded upper and lower regions on the input plots are infeasible regions beyond the input constraints. The controller adjusted the fuel rate and damper angle to achieve both optimal burning efficiency and allowable carbon levels. There are no violations of input constraints.

FIG. 10 presents the SBMPCBPN Case 2 results. Penalties on CO and CO₂ are introduced and Inputs, O₂ tracking, and carbon levels are plotted. The controller adjusted the fuel rate and damper angle to seek both optimal burning efficiency and allowable carbon levels. There are no violations of input constraints. The predicted and desired curves match, which indicates that neural network prediction error is the cause of the error in tracking between actual and desired concentrations.

FIG. 11 presents the Neural GPC Case 3 results. With plant changes occurring every 500 seconds, the model adapts and control inputs are updated simultaneously. The shaded upper and lower regions on the input plots are infeasible regions beyond the input constraints. The value u_{2,SAT} is input to the plant when the fuel rate constraint violation occurs. Because of this saturation of u₂, tracking is unsuccessful as u₁ alone lacks the control authority to track the reference.

FIG. 12 presents the SBMPC_{RBF} Case 3 results. SBMPC_{RBF} successfully adapts to the plant changes at 500 second intervals, and once converged, low tracking error and output constraint satisfaction is achieved.

FIG. 13 presents the SBMPC_{BPN} Case 3 results. SBMPC_{BPN} adapts to the plant changes. The predicted and desired curves match, which indicates that neural network prediction error is the cause of the error in tracking between actual and desired concentrations.

FIG. 14 is an exemplary flow chart of a method for adaptive nonlinear model predictive control of multiple input, multiple output systems.

FIG. 15 is an exemplary flow chart of a method for adaptive nonlinear model predictive control of multiple input, multiple output systems.

### DETAILED DESCRIPTION OF THE INVENTION

An important application of neural networks is the identification of the dynamics of a nonlinear system with no known closed-form model, especially a system whose dynamic behavior may change with time. When this is done quickly and robustly, the model may be used for closed-loop Nonlinear Model Predictive Control (NMPC). NMPC methods that rely on linearization about an equilibrium point or excessive parameter tuning require a priori information that limits the robustness of those methods for a system with changing dynamic behavior. The present disclosure comprises a novel method for adaptive NMPC of multiple input, multiple output (MIMO) systems, called Sampling Based Model Predictive Control (SBMPC) that, like most MPC approaches, has the ability to enforce hard constraints on the system inputs and states. However, unlike other NMPC methods, it does not rely on linearizing the system or gradient based optimization. Instead, it discretizes the input space to the model via pseudo-random sampling and feeds the sampled inputs through the nonlinear plant, hence producing a graph for which an optimal path can be found using an efficient graph search method such as LPA* optimization. Although SBMPC can be applied to any form of a nonlinear model, here a radial basis function neural network is used to model the nonlinear system due to its ability to represent a very general class of nonlinear systems. Using the Minimal Resource Allocation Network (MRAN) learning algorithm, the neural network size and parameter values may be adjusted even while the controller is active. After presenting the general methodology, Adaptive SBMPC is used in simulation to control the chemical concentrations of flue gas exiting a steam boiler's combustion chamber, represented by a 3-state time-varying nonlinear model with two inputs and three outputs.

The present disclosure comprises an adaptive NMPC approach known as Adaptive Sampling Based Model Predictive Control (Adaptive SBMPC). The optimization approach, which discretizes the input space using sampling, does not require gradient computation and easily handles the changes in model structure that occur as a neural network grows or shrinks. The approach introduced here has potential application in a wide variety of domains, including process control, automotive engine control, power system control, and robot motion planning.

Sampling Based Model Predictive Optimization, the optimization portion of SBMPC, has been successfully applied to trajectory generation for robot systems with highly nonlinear plant dynamics [15]. However, in those applications, the dynamics were well known and modeled analytically. In addition, a receding horizon was not used. In the present invention SBMPO is used with a receding horizon, hence becoming SBMPC. More importantly, the nonlinear model is identified online and updated while the system is being controlled. Hence, this is the first adaptive form of SBMPC and it is demonstrated that this method is feasible for real time implementation.

To model nonlinear dynamics, a special class of neural networks was employed, called the Radial Basis Function (RBF) network, which has been shown to be general enough to represent arbitrary nonlinear functions of multiple variables. In the present invention an RBF network is trained and adapted online using the Minimal Resource Allocation Network (MRAN) learning algorithm to produce high-fidelity nonlinear models from limited sequences of training data.

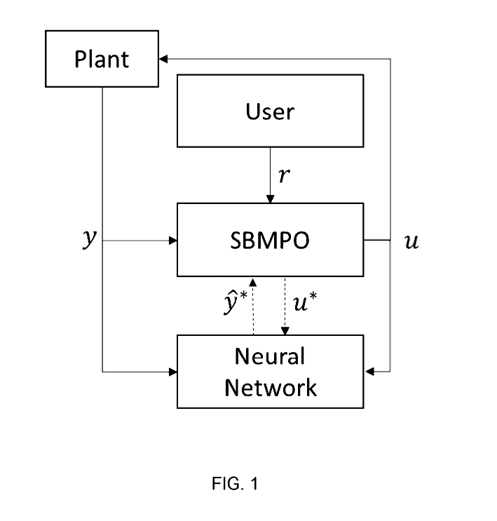

The Adaptive SBMPC approach to nonlinear MPC consists of identification of an approximate system model during the learning phase followed by simultaneous identification and control during the control phase. As shown in FIG. 1, a neural network is used to model the plant dynamics and SBMPC is used to generate actuation signals to control the plant. A summary of the MRAN identification algorithm and the details of the SBMPC methodology is described below.

The Minimal Resource Allocation Network (MRAN) algorithm implemented in the present invention is well known in the art. It is based on the Resource Allocation Network algorithm, a general method for function approximation. The advantage over other methods is that the network eventually reaches a constant size despite increasing the length of the training set. Prior research has extended RAN to MRAN by adding a pruning step. MRAN has been applied here to process control, but it is sufficiently general to represent many other systems with little or no alteration of the algorithm's tuning parameters.

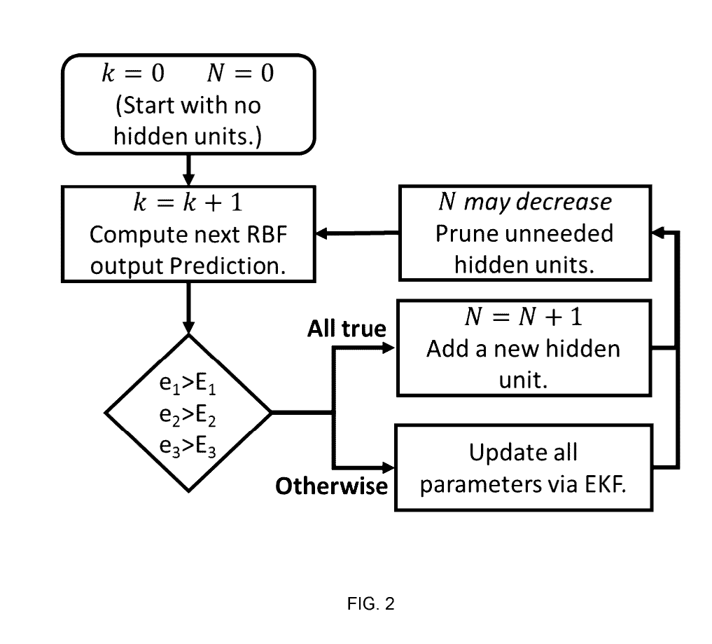

The MRAN algorithm, depicted in FIG. 2, begins with an empty network (N=0) and uses prediction error criteria at each time step k to determine whether an additional hidden unit is necessary to represent the system. In each algorithm iteration, the network is refined to reduce prediction error either via addition of a hidden unit or an Extended Kalman Filter (EKF) adjustment of the parameter vector of all current hidden units. Hidden units that have low relative contribution over a designated number of time steps Mₚ are removed from the network in the pruning stage.

This present invention extends the MRAN pruning logic by allowing multiple pruning criteria, each represented by a significance threshold δₚₖ and consecutive limit M_{p,k}. If any one of these criteria is met by a given hidden unit, the unit is pruned. By allowing for pruning behavior that specifies both fast-acting pruning behavior (with smaller δₚₖ) and long-acting pruning behavior (with larger δₚₖ), the multistage approach to pruning gives more flexibility to trade off network size and prediction accuracy.

Control systems based on system identification typically have a learning phase, during which an excitation signal is input to the system in open loop in order to initially model its dynamics. Some real systems, however, could potentially produce undesirable outputs if the command signal is purely open loop. In these cases, it is helpful to employ a low level controller that is active during the learning phase to prevent unsafe or undesirable states.

As a means of solving Model Predictive Optimization problems without computing gradients, Sampling Based Model Predictive Control (SBMPC) has been developed and implemented on experimental platforms. SBMPC may be applied to solve the nonlinear optimization problem described by Equation 1,

$${min}_{\{ u ( k ) … u ( k + N - 1 ) \}} {\sum }_{i = 0}^{N - 1} C ( y ( k + i + 1 ) - r ( k + i + 1 ) ) \qquad ( 1 )$$

where the cost function C(•)≧0, subject to the nonlinear state space equations of Equations 2 and 3,

a. x(k+i)=g(x(k+i−1),u(k=i−1)), (2)

b. y(k)=h(x(k)), (3)

and the constraints,

c. x(k+i)εX_{free}∀ i≦N, (4)

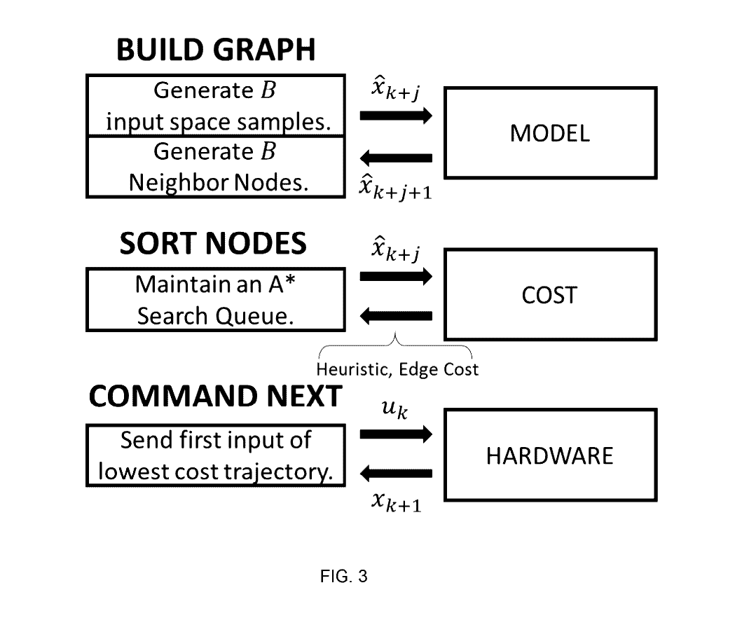

u(k+i)εU_{free}∀ i≦N, (5)

where r(k) is the reference input and X_{free} and U_{free} represent the states and inputs respectively that do not violate any of the problem constraints. SBMPC is described in FIG. 3 and is easily applied to both linear and nonlinear models, combining techniques for sampling the input domain with an efficient graph search method such as LPA*. Details of SBMPC can be found in the prior art. Below, two aspects of SBMPC are emphasized.

The field of path planning in robotics has seen recent innovations that have used sampling techniques. SBMPC involves the sampling of the space of allowable inputs. Halton sampling, in particular, is a method based on the low-discrepancy Halton sequences that has been shown to provide representative sample sets consisting of fewer points than sets generated using pseudo-random numbers or regular grids. Satisfaction of input constraints is automatic, since it is the allowable inputs that are sampled, and since the inputs are propagated forward through the model, no inversion of the model is needed.

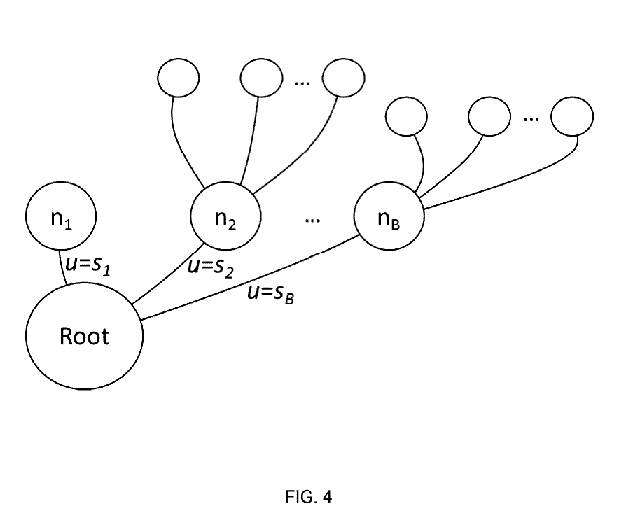

Using the current state and input samples, several nodes are computed by propagating the model and added to a graph with tree connectivity, as illustrated in FIG. 4. The branchout factor B, a tuning parameter of the algorithm, determines how many child nodes are generated when a particular parent node is expanded.

A simulation of the application of the present invention related power plant combustion, was used to demonstrate both Adaptive SBMPC and Neural GPC. The plant description below is taken as ground truth, and the dynamics described are initially unknown to the algorithms. The RBF and BPN neural network identification algorithms were tasked with learning the plant behavior.

The PK 401 boiler, used for power generation of up to 200 megawatts, has a combustion process that has been previously modeled. For this embodiment, two inputs and three outputs were considered. The first input, the air flow damper angle φε[0°, 90°] determines the volume flow rate of air, (m³/s), according to the relationship in Equation 6,

$$a . Φ = \{ \begin{matrix}\frac{{Φ}_{max}}{2} exp ( \frac{φ - 45}{15} ) , & 0 ° \leq φ \leq 45 ° \\ \frac{{Φ}_{max}}{2} ( 2 - exp ( \frac{45 - φ}{15} ) ) , & 45 ° \leq φ \leq 90 °\end{matrix} \qquad ( 6 )$$

where Φₘₐₓ specifies the air flow when the damper is fully open. This nonlinear damper-to-flow relationship is known in the art. Air was assumed to be composed of 79% nitrogen and 21% oxygen.

The second input was fuel mass rate Φ_{f}ε[0.7, 1.3] kg/s. Modifying these two inputs influences chemical concentrations in the flue gas exiting the boiler. The three gas concentrations of interest, x_{O}_{₂}, X_{CO}, x_{CO}_{₂}ε[0%, 100%], were the outputs of the control system and change according to Equations 7 through 9:

$$\begin{matrix}a . {\dot{x}}_{{O}_{2}} = \frac{- {x}_{{O}_{2}} ( Φ + {Φ}_{f} ( {V}_{d} - {V}_{O} ) + 21 Φ - 100 {V}_{O} {Φ}_{f} )}{V} , & ( 7 ) \\ b . {\dot{x}}_{CO} = \frac{- {x}_{CO} ( Φ + {Φ}_{f} ( {V}_{d} - {V}_{O} ) + 1.866 {ax}_{c}^{f} {Φ}_{f} )}{V} , & ( 8 ) \\ c . {\dot{x}}_{{CO}_{2}} = \frac{- {x}_{{CO}_{2}} ( Φ + {Φ}_{f} ( {V}_{d} - {V}_{O} ) + 1.866 ( 1 - a ) {x}_{c}^{f} {Φ}_{f}}{V} , & ( 9 )\end{matrix}$$

where V_{d} (m³/kg) is the theoretical volume of gas produced by the combustion of 1 kg of fuel, V_{O} (m³/kg) is the theoretical volume of O₂ needed for total combustion of 1 kg of fuel, a is the fraction of Carbon that reacts to form CO, x_{C}^{f} is the Carbon fraction of the fuel mass, and V (m³) is the chamber volume. The numerical value of each of the parameters used in the simulation is presented in Table 1.

TABLE 1
SIMULATION PARAMETERS

| Symbol | Parameter | Value(s) |
|---|---|---|
| V_{d} | Gas Production Constant | 2.399 × 10⁻³ m³/kg |
| V_{O} | O₂ Consumption Constant | 1.543 × 10⁻³ m³/kg |
| x_{c}^{f} | Fuel Carbon Fraction | 0.8087 |
| V | Volume of Chamber | 0.01 m³ |
| Φₘₐₓ | Maximum Air Flow | 1.833e⁻² |
| T | Control Period | 10 s |
| τ | Simulation Integration Step | 1 × 10⁻⁴ s |

The concentration of x_{O}_{₂} was monitored as a metric of efficiency. For this particular boiler, x_{O}_{₂} was compared to the value that is optimal for burning efficiency x_{O}_{₀₂}_{,opt}, a value that has been previously prescribed as an empirical function of Φ_{f}. When the flue concentration is above optimal, the oxygen-rich reaction is burning at excessive temperature, and energy is wasted via heat in the flue gas. In oxygen-deficient reactions, where the flue concentration is below optimal, energy is wasted in the form of unburned fuel escaping in the flue gas.

In order to consider the boiler's environmental impact as well as its mechanical efficiency, the known O₂-only analytical model has been extended to compute carbon monoxide (CO) and carbon dioxide (CO₂) concentrations as well. Both pollutants are regulated by the UN Kyoto Protocol as well as by governments of individual nations, which tax excessive carbon emissions. CO₂ is the most prominent and strictly-regulated greenhouse gas, and in proximity to humans, CO excess is harmful and potentially fatal. While the embodiments of the present included these two greenhouse gasses, other key pollutants such as nitrous oxides (NOₓ) were not considered because their formation process is not well understood.

Identification of the nonlinear system dynamics was achieved by training both RBF and BPN neural network models. The MRAN identification algorithm, described above, was used to train the RBF network, while the more standard back propagation adaptation rule was used to train the BPN network. A key distinction between the two identification approaches is that for BPN, a fixed network size must be assumed, while the RBF adds new hidden units when needed to model newly seen data.

For this simulation, the BPN network was initialized with random parameters for each hidden unit, and the RBF network was initialized with no hidden units. To determine the network size for the BPN network, system identification simulations were run with integer network sizes between 1 and 400 hidden units. The network size of 39 hidden units produced the smallest cumulative error, so this network size was assumed for the cases presented. The ability to learn the size of the network while the identification algorithm runs is an advantage of MRAN learning over back propagation.

The simulation was run on one CPU core of a 2.0 GHz quad-core AMD laptop with 6 gigabytes of RAM. All algorithms were implemented in C.

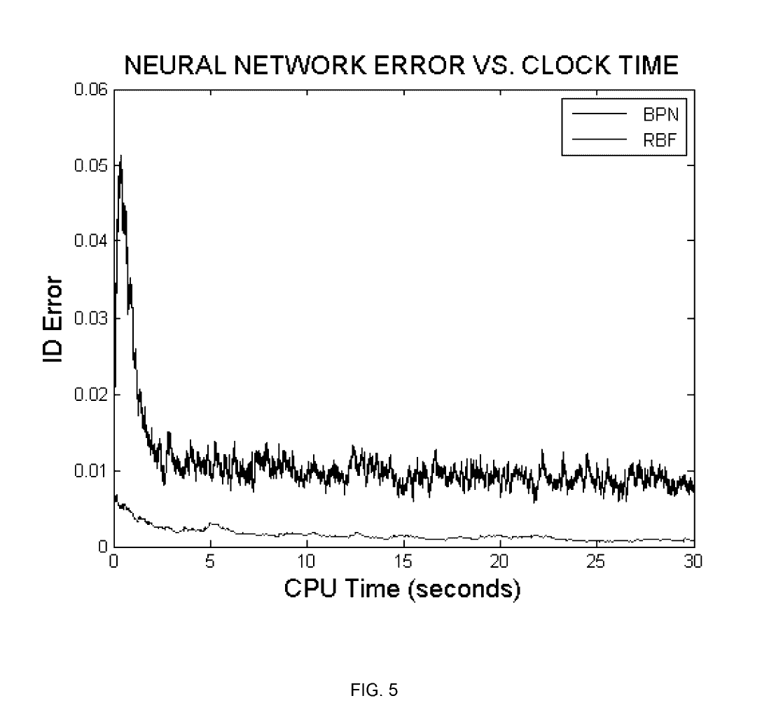

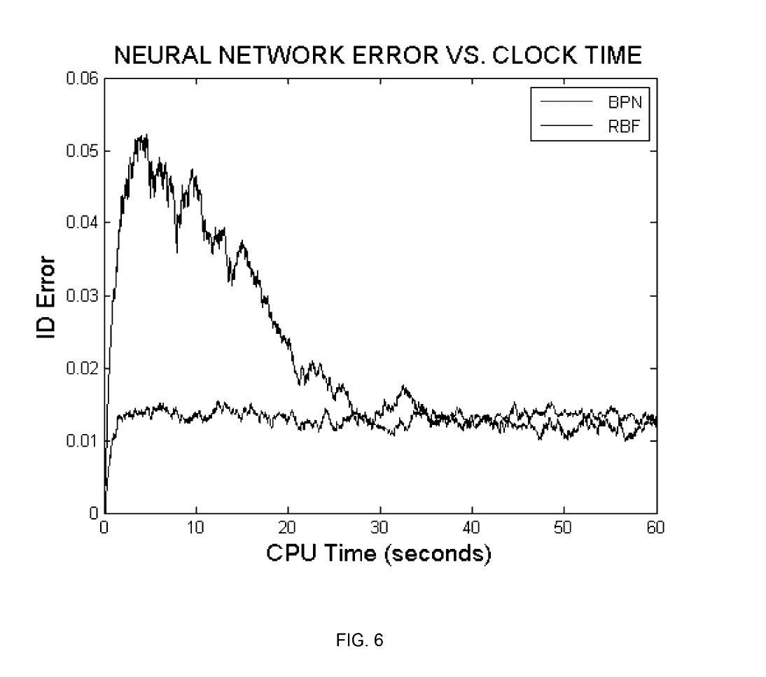

During neural network training, a sequence of white noise over the allowable range for each input was provided as the open loop excitation signal. These signals as well as the measured outputs that result from the inputs were sequentially passed to the identification algorithms. Identical sequences were used for the BPN and RBF networks. Comparison FIGS. 5 and 6 plot the error metric of Equation 10,

a. e_{pred}(k)=Σᵢ₌₀¹⁰⁰∥y(k−i)−\hat{y}(k−i)∥, (10)

where ∥•∥ denotes the Euclidean norm, on the vertical axis and the CPU time on the horizontal axis. While in the single output case, FIG. 5, the RBF network predicts with lower error than the BPN network, the prediction error between the two is comparable in the three output case, FIG. 6.

The process of tuning the MRAN algorithm includes the tuning of the Extended Kalman Filter parameters, q, p₀, and R. These were tuned according to procedures known in the art. Next, the error thresholds, E1, E2, and, E3, and the pruning thresholds, δ_{p,1} and δ_{p,2}, were given values of 0, resulting in automatic addition of a hidden unit, with no pruning possible, at each time step. The remaining parameters were set with an initial guess based on parameters used in another application of MRAN. From this starting point, the thresholds were systematically increased by monitoring the error data values of e₁, e₂, and e₃ during the execution of MRAN with training data. These initial values result in rapid growth of the number of hidden units. The network was then tuned to slow this growth. After each run, each error threshold parameter was modified by computing the 20^{th} percentile of the corresponding error data. This process was repeated until the resulting post-training size of the neural network decreased to about 200. This size represented an acceptable trade-off between prediction accuracy and computational time. Likewise, the pruning thresholds, δ_{p,1} and δ_{p,2}, were modified using the 1^{st} and 1/10^{th} percentile values of e₂. The resulting tuning parameter choices are given in Table 2.

TABLE 2
MRAN PARAMETER CHOICES

| Symbol | Parameter | Value(s) |
|---|---|---|
| E1 | Instantaneous Error Threshold | 0.00209 |
| E2 | RMS Error Threshold | 0.005 |
| E3 | Basis Vector Spacing Threshold | 0.16 |
| E3_{DEC} | E3 Geometric Decay Rate | 0.9985 |
| E3_{MIN} | E3 Decay Floor | 0.03 |
| M | RMS Average Window | 48 |
| N* | Maximum Hidden Units | 480 |
| κ | Overlap Factor | 10.0 |
| q | Kalman Step Parameter | 0.5 |
| p₀ | New Parameter Variance | 5.0 |
| R | Assumed Sensor Noise Variance | 0.0 |
| M_{p,1} | Pruning Window 1 | 800 |
| M_{p,2} | Pruning Window 2 | 2000 |
| δ_{p,1} | Pruning Threshold 1 | 2 × 10⁻⁸ |
| δ_{p,2} | Pruning Threshold 2 | 1 × 10⁻⁴ |

The tuning parameters for the BPN identification algorithm, given in Table 3, were chosen through an iterative process, beginning with an initial guess based on parameters α, η, and L that were used in another application. From this starting point, the parameters were modified and used for an identification simulation. The parameter configuration yielding the smallest overall prediction error was retained. Since BPN requires outputs scaled within 0 and 1, the scaling multiplier and biases were selected to transform the outputs into the range [0,1], based on the minimum and maximum y values observed in the training data. The number of hidden units N_{H} was selected by running the BPN algorithm on the training data for each N_{H} between 1 and 400 and selecting the value resulting in the lowest prediction error.

TABLE 3
BPN PARAMETER CHOICES

| Symbol | Parameter | Values(s) |
|---|---|---|
| N_{H} | Hidden Units | 19, 39, 39* |
| α | Learning Rate | 5.7 |
| η | Momentum Coefficient | 5000, 2778.7, 2778.7* |
| L | Network Gain | 0.007 |
| M₁ | y₁ Scaling Multiplier | 6.0 |
| B₁ | y₁ Scaling Bias | 0.0 |
| M₂ | y₂ Scaling Multiplier | 10^{5†} |
| B₂ | y₂ Scaling Bias | 0.5^{†} |
| M₃ | y₃ Scaling Multiplier | 2.0^{†} |
| B₃ | y₃ Scaling Bias | 0.0^{†} |

*Case 1, Case 2, and Case 3, respectively.
^{†}Only applicable to Cases 2 and 3.

In order to clearly compare the control results, Adaptive SBMPC was implemented not only in the typical configuration, using the RBF network, but also with the BPN network used by Neural GPC. These two implementations are here referred to as SBMPC_{RBF} and SBMPC_{BPN}. Three cases are presented: a SISO problem, a MIMO problem, and a time-varying MIMO problem. The two control inputs and outputs are given by Equation 11,

a. u₁=φ, u₂=Φ_{f}, (11)

b. and the three plant outputs are given by Equation 12:

c. y₁=x_{O}_{₂}, y₂=x_{CO}, y₃=x_{CO}_{₂} (12)

The second input, fuel mass rate Φ_{f}, is prescribed over time as an exogenous input in Case 1, but specified by SBMPC or GPC as a control input in Cases 2 and 3. The outputs to be controlled are the flue volume concentrations of oxygen, carbon dioxide, and carbon monoxide.

For each trial, 120 seconds of processor time was used to initially train the neural network. During this phase, inputs consisted of uniform white noise within the constrained range for each input, u₁(k)ε[0°,90°] and u₂(k)ε[0.7,1.3] kg/sec. The MRAN learning algorithm starts with an empty neural network and learns the network size during this training period. The back propagation network, initialized with random hidden unit parameters between −0.5 and 0.5, assumed a fixed network size, which was provided a priori. The same prediction horizon N=4 and control horizon N_{C}=2 were used for both SBMPC and GPC. The complete list of tuning parameters is given in Tables 2 and 3 above and in Tables 4 and 5.

TABLE 4
SBMPC PARAMETER CHOICES

| Symbol | Parameter | Value(s) |
|---|---|---|
| B | Branchout Factor | 60 |
| N | Prediction Horizon | 4 |
| N_{c} | Control Horizon | 2 |

TABLE 5
GPC PARAMETER CHOICES

| Symbol | Parameter | Value(s) |
|---|---|---|
| N | Prediction Horizon | 4 |
| N_{c} | Control Horizon | 2 |
| ε | Solver Tolerance | 10⁻⁶ |
| Iₘₐₓ | Maximum Newton Iterations | 1500 |
| s | Constraint Sharpness | 10⁻¹⁵ |
| λ | Damping Factor | 4 × 10⁻³ |
| | | 9 × 10⁹ |
| | | 9 × 10⁹* |

*Case1, Case 2, and Case 3, respectively.

Case 1: Time-Invariant SISO Problem

The first simulated case was the in which only the mechanical efficiency of the burner was considered for optimization. In this case, Φ_{f} was specified externally, and only a single control input φ was used. The control task was to seek the concentration of oxygen x_{O}_{₂} in the flue gas that was optimal for burning efficiency x_{O}_{_{2,opt}}, a value that was prescribed as a function of Φ_{f}. The cost function being optimized is presented in Equation 13,

a. C=Σᵢ₌₀^{N-1}C_{mec}(i) (13)

b. has a single quadratic cost term given by Equation 14,

c. C_{mec}(i)=(x_{O}_{₂}(k+i)−x_{O}_{_{2,opt}}(k+i))² (14)

d. and control signals were determined by sampling inputs in bounded increments such that Equation 15 is true,

e. −0.5°≦Δφ≦0.5° (15)

f. in any two consecutive time steps.

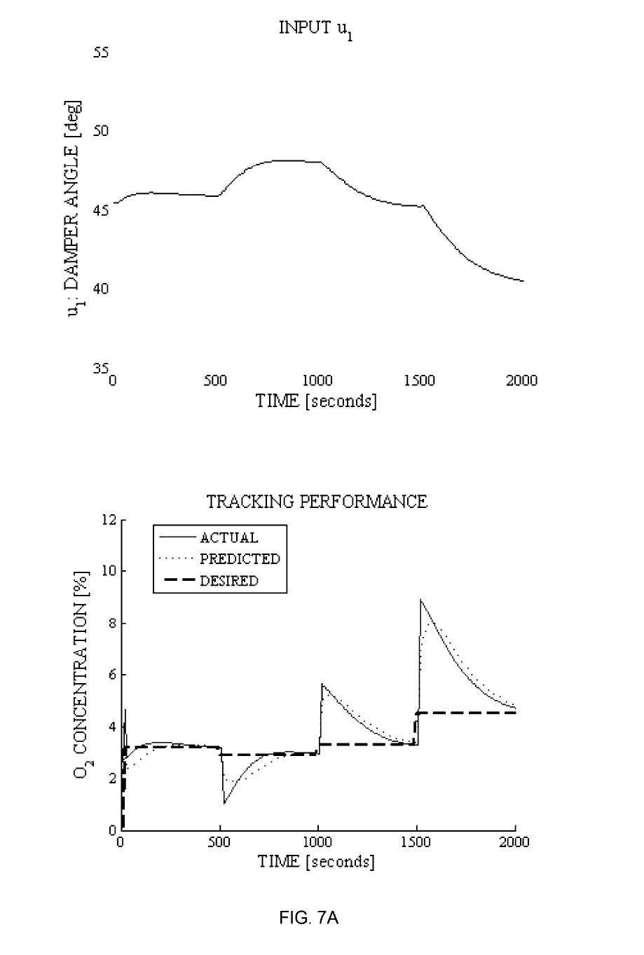

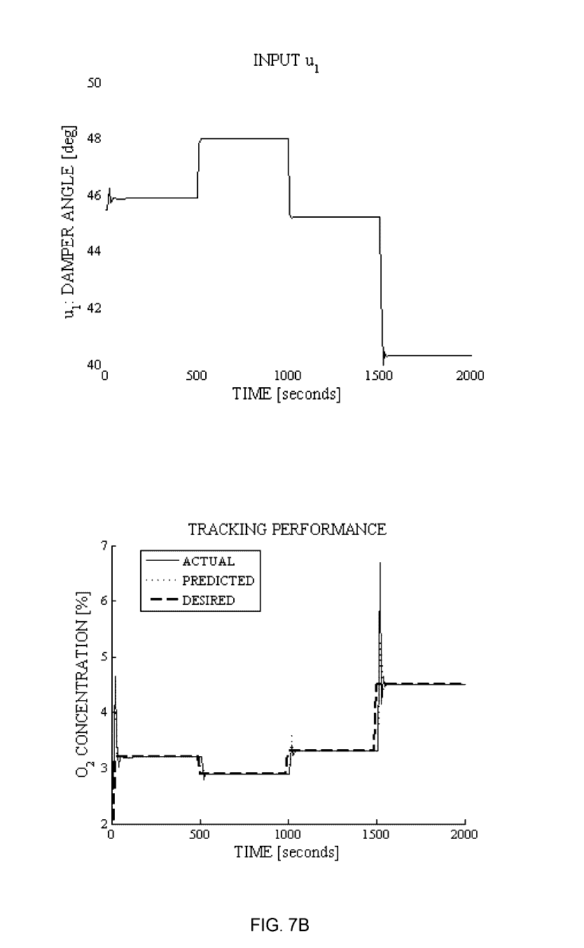

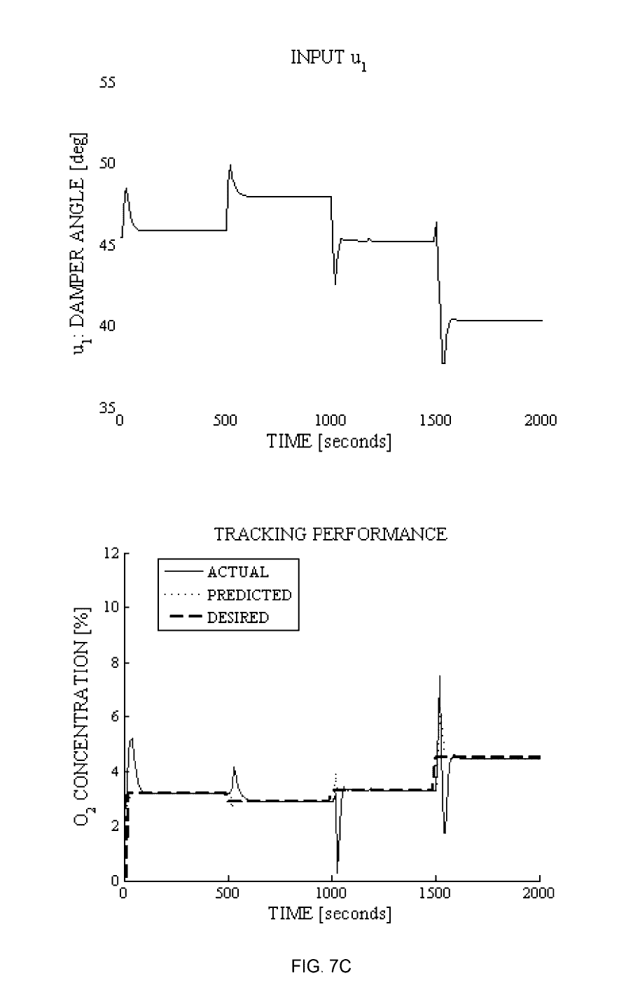

After the 60-second learning phase for Case 1, the number of RBF hidden units had converged to 19. The number of hidden units remained constant throughout the control phase of the simulation. SBMPC and GPC both successfully used the learned models to track the reference signal. The results from three run configurations when Neural GPC was used is presented in FIG. 7A, when SBMPC_{RBF} was used is presented in FIG. 7B, and when SBMPC_{BPN} was used is presented in FIG. 7C. SBMPC demonstrated more rapid convergence for the SISO case, while requiring less computation time as seen in Table 6. The neural network performance was similar, as seen by comparing SBMPC_{RBF} and SBMPC_{BPN} plots, although SBMPC_{RBF} achieved lower overshoot, due to initially larger prediction errors of the BPN network.

TABLE 6
ADAPTIVE SBMPC RUN TIME STATISTICS

| Plant | Control Algorithm | | |
|---|---|---|---|
| Configuration | N. GPC | SBMPC_{RBF} | SBMPC_{BPN} |

Median CPU Times

| | | | |
|---|---|---|---|
| Case 1 | 4 ms | 3 ms | 1 ms |
| Case 2 | 1780 ms | 583 ms | 1050 ms |
| Case3 | 1770 ms | 790 ms | 804 ms |

Longest CPU Times

| | | | |
|---|---|---|---|
| Case 1 | 3770 ms | 821 ms | 1950 ms |
| Case 2 | 7790 ms | 1780 ms | 2120 ms |
| Case 3 | 7350 ms | 4720 ms | 7720 ms |

Case 2: Introducing a Carbon Penalty Cost

Case 2, and extension to three outputs, considers greenhouse gases CO and CO₂ in order to control environmental impact of the power plant. The updated cost function is given by Equation 16,

a. C=Σᵢ₌₀^{N-1}Cₑₙᵥ(i)+C_{mec}(i) (16)

where

b. Cₑₙᵥ=C_{CO}+C_{CO}_{₂} (17)

and

$$\begin{matrix}c . {C}_{CO} = \{ \begin{matrix}0 , & {x}_{CO} < {L}_{CO} \\ ( {x}_{CO} - {L}_{CO} ) {P}_{CO} , & {x}_{CO} < {L}_{CO}\end{matrix} & ( 18 ) \\ d . {C}_{{CO}_{2}} = \{ \begin{matrix}0 , & {x}_{{CO}_{2}} < {L}_{{CO}_{2}} \\ ( {x}_{{CO}_{2}} - {L}_{{CO}_{2}} ) {P}_{{CO}_{2}} , & {x}_{{CO}_{2}} < {L}_{{CO}_{2}}\end{matrix} & ( 19 )\end{matrix}$$

The cost function introduces terms that linearly penalize pollutant levels above the respective thresholds L_{CO}_{₂} and L_{CO} with penalty slopes P_{CO} and P_{CO}_{₂}. The limitations on CO and CO₂ are implemented as soft constraints via these linear penalties rather than hard constraints. This is done because initial conditions and time variation of the plant yield states in violation of the desired range of outputs. Starting from this initial condition, the use of hard constraints would allow no feasible solutions. Instead, a large penalty was placed on outputs above desired levels to so that optimal control strategies must quickly bring the outputs into compliance.

For Cases 2 and 3, there were two control inputs, air inlet damper angle φ and fuel rate Φ_{f}. In addition to the constraints on the damper angle, fuel rate is constrained on {uₘᵢₙ, uₘₐₓ}={0.7 kg/s, 1.3 kg/s}. A saturation function given by Equation 20,

$$e . {u}_{SAT} ( u ) = \{ \begin{matrix}{u}_{max} , & u < {u}_{min} , \\ u , & {u}_{min} \leq u \leq {u}_{max} , \\ {u}_{max} , & u > {u}_{max}\end{matrix} \qquad ( 20 )$$

f. is applied to the control signals, so that whenever either of the constraints is violated, the limiting value is passed to the plant instead. The reference trajectory x_{O}_{_{2,opt}}, a sinusoid, simulates the requirement of power plant boilers to meet demands that vary over time.

For case 2, the length of the training phase was 120 seconds. After the training phase, the number of hidden units converged to 199. By the end of the simulation, the number of units had increased to 201.

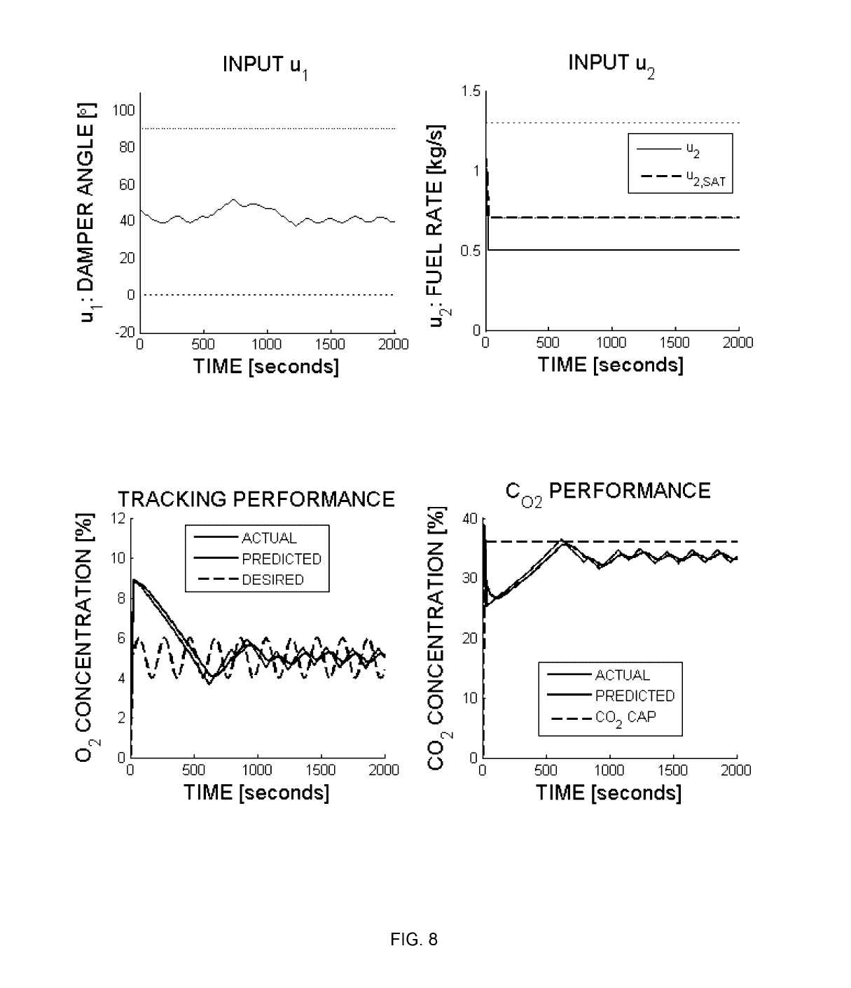

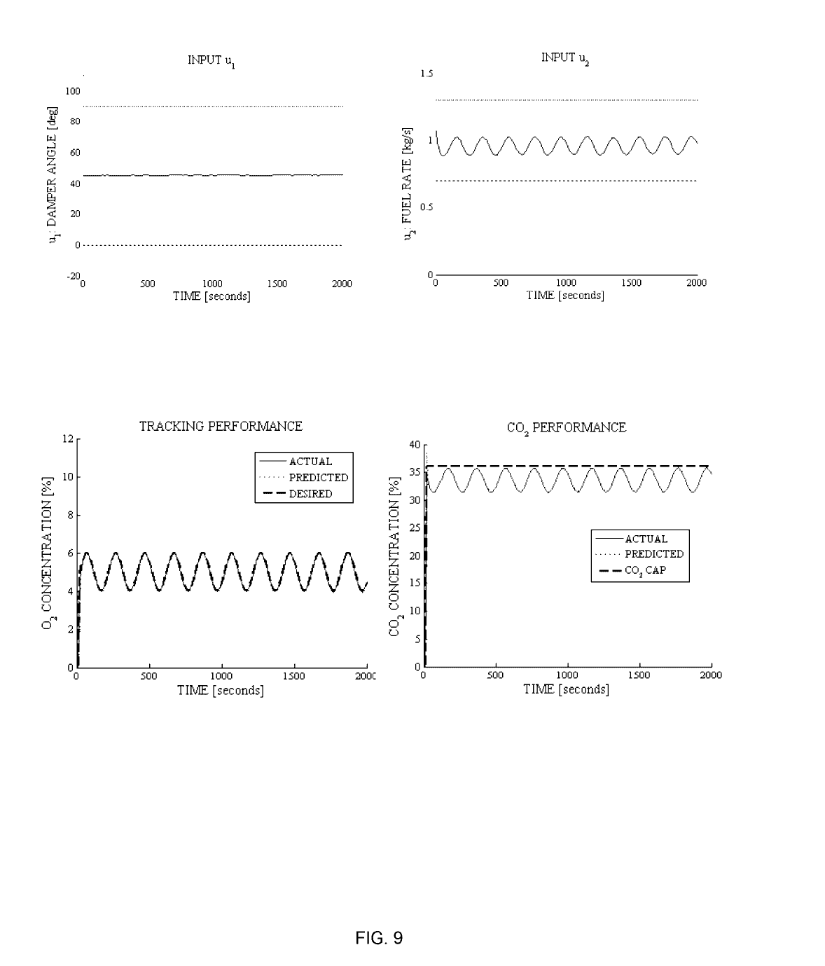

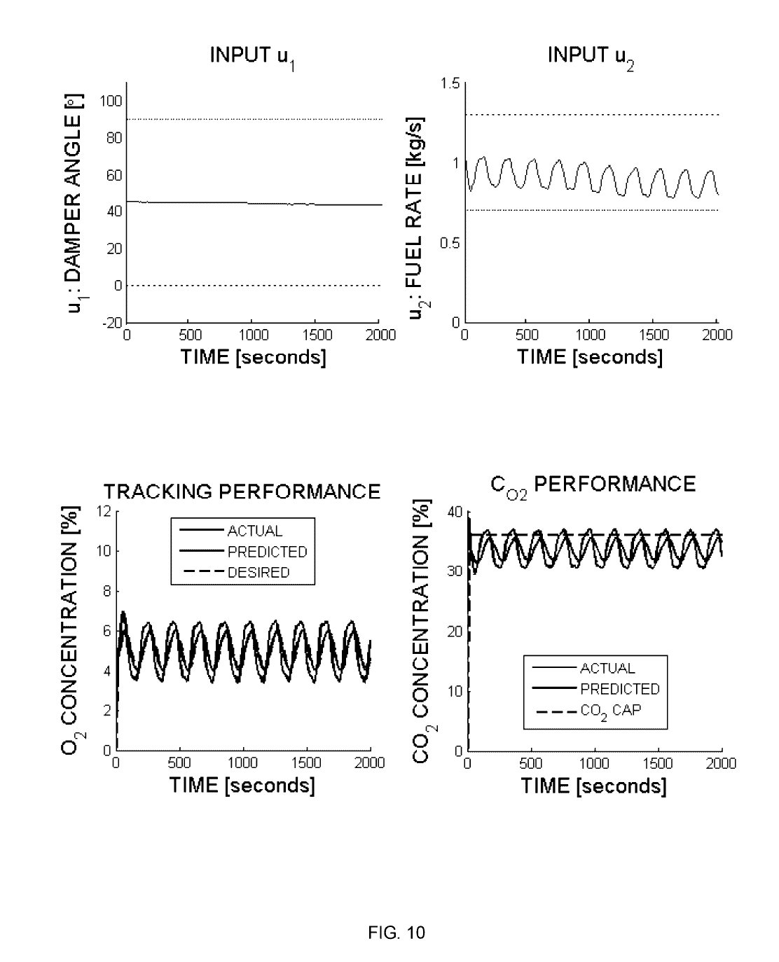

The data for the second case, shown in FIG. 8, FIG. 9, and FIG. 10, gives the Case 2 results for Neural GPC, SBMPC_{RBF}, and SBMPC_{BPN}, respectively. CO levels, which remained at zero throughout the control phase, are not plotted. Although CO was generated during the training phase, by nature of the combustion process the constraint on CO₂ is the more stringent of the two constraints, and meeting the constraint on CO₂ forced the CO level to zero. In FIG. 8, Neural GPC fails to track the reference due to an input constraint violation, which occurred because GPC produced a fuel rate that was out of bounds. The damper angle alone lacks the control authority to track the reference trajectory. SBMPC_{RBF} converges with small error and satisfaction of output constraints as shown in FIG. 9. Prediction errors are rapidly corrected in the first few time steps of the control phase. FIG. 10 illustrates that SBMPO_{BPN} network similarly achieves overall constraint satisfaction, but the tracking is less effective due to the prediction error of BPN. The execution time of SBMPO_{RBF} was improved over that of SBMPO_{BPN}, as seen in Table 6, which is primarily due to the smaller number of graph node expansions required when model predictions are more accurate. This time is also directly proportional to number of hidden units required to represent the system. The MRAN algorithm converged to 201 hidden units, whereas the fixed number of hidden units for the BPN network was 39.

Case 3: Control System Adaptation Under Changing Dynamics

The third simulation case demonstrates the versatility of the adaptive algorithms as changes in plant dynamics are introduced that require active model updates. The online identification algorithms are able to quickly adjust to changing plant behavior, either by back-propagation (BPN) or the EKF optimization of MRAN (RBF).

In the simulation, plant dynamics were applied as step parameter changes at the beginning of each 500 second interval of simulation time. The nature of the changing boiler dynamics is presented in Table 7. Each change is from the normal dynamic behavior, such that the changes mentioned are in effect during the interval but revert back to the normal values.

TABLE 7
TIME VARIATION OF SIMULATION PLANT DYNAMICS

| Time (s) | Description | Quantitative Changes |
|---|---|---|
| 0 to 500 | Normal Boiler Operation | None |
| 500 to 1000 | Constricted Air Flow | Φₘₐₓ is 36% smaller |
| 1000 to 1500 | Damp Fuel | H₂O added to comprise 5% of |
| | | fuel mass |
| 1500 to 2000 | Smaller Chamber Volume | 15% reduction in volume |

For case 3, the length to the training phase was 120 seconds. After the training phase, the number of hidden units converged to 199. By the end of the simulation, the number of units had increased to 205.

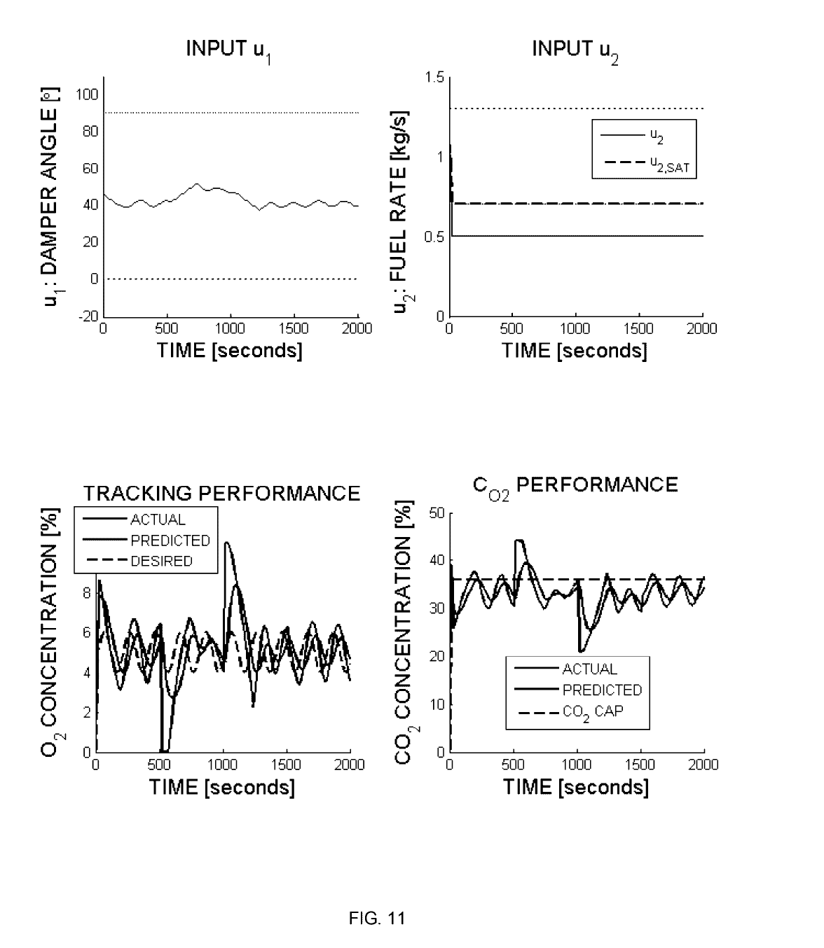

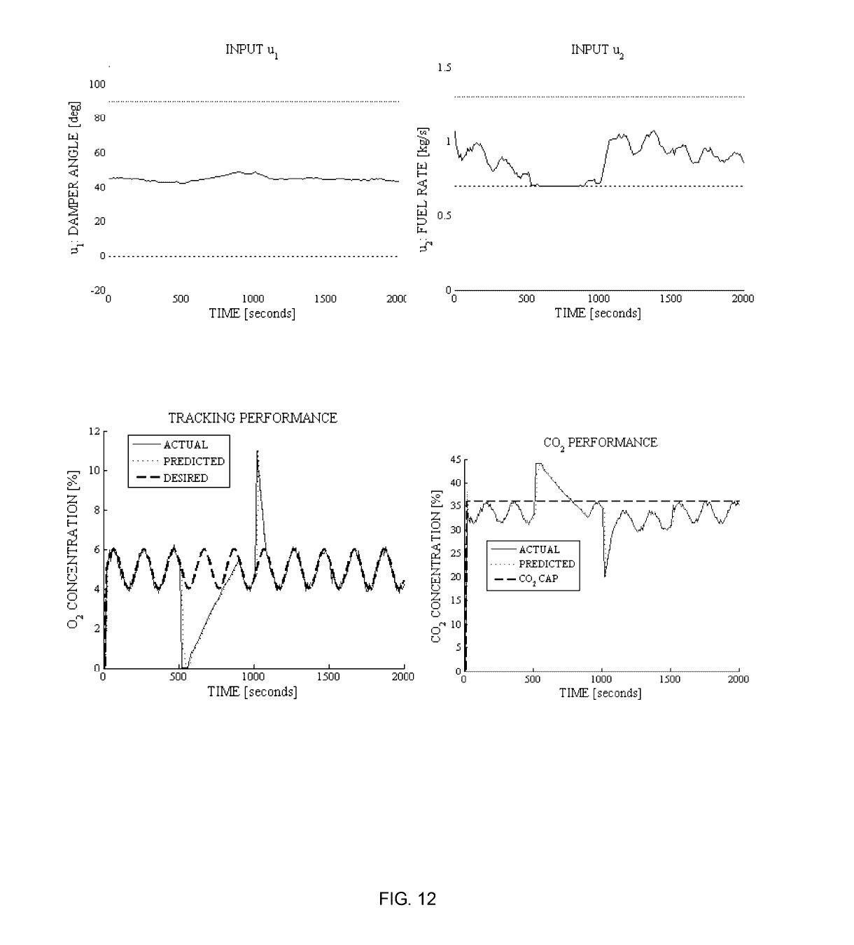

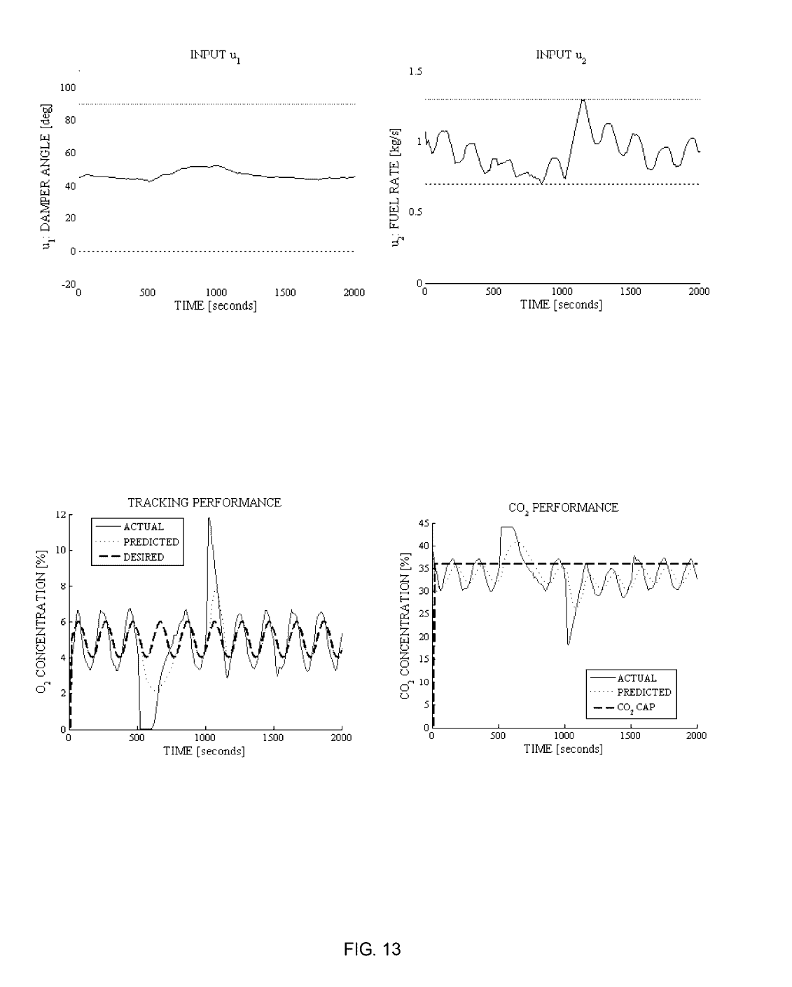

The data for the third case, shown in FIG. 11 for Neural GPC, FIG. 12 for SBMPC_{RFB}, and FIG. 13 for SBMPC_{BPN}, indicate that after each shift in plant dynamics, the neural networks were adapted and prediction errors were corrected. In FIG. 11, Neural GPC exhibited significant and sustained tracking error due to the u2 input constraint violation that was mentioned previously. SBMPC_{RBF} achieved similar tracking behavior as shown in FIG. 12 and did not violate the input constraints. Similar results were produced by SBMPC_{BPN} as shown in FIG. 13, and no input constraints were violated. After each plant change, the neural networks quickly adapt to decrease the prediction error and, as in Case 2, the improved neural network prediction accuracy leads to lower computational cost for SBMPC_{RBF} compared to SBMPC_{BPN}.

Run Time Statistics and Real Time Feasibility

The computational times presented in Table 6 were measured during simulation execution for each of the three cases. The timing period begins before the SBMPC or GPC control routine and ends after control routine has computed the next control input. Median and worst case performance over each simulation run are presented. Benchmarking statistics of median and longest CPU times are given. The longest CPU times reflect the transient solve times that occur initially, and the median CPU times indicate the computation cost after these transient periods. The control period for this application is 10 seconds, so the measured computational times are all within feasibility requirements for real time implementation. The real time requirement was met by each algorithm, but compared to GPC, SBMPC achieved better overall computation performance in addition to better tracking performance. Either algorithm could be tuned to run more quickly, but this comes at the expense of diminished tracking performance.

Tuning the Control Algorithms

Compared with the neural network algorithms, the NMPC algorithms involved less effort to tune. For both SBMPC and GPC the prediction horizon N=4 was chosen large enough to limit the overshoot of the transient behavior of the controlled system. For both algorithms the control horizon N_{C}=2 was chosen to keep the computations small.

After these were fixed, the only remaining SBMPC tuning parameter is the branchout factor B. This parameter allows a trade-off between low computational cost (small B) and low tracking error (large B). The value B=60 was selected after trial simulations with various values.

In order to tune the Newton solver of GPC, a solver tolerance e, iteration limit Iₘₐₓ, input constraint sharpness s, and damping factor λ were selected. The parameters ε and Iₘₐₓ allow for a trade-off between computational cost and tracking error, so they were selected to match the Case 1 steady state tracking error performance of SBMPC. The parameters s and λ, if not properly selected, led to instability of GPC. The damping factor was selected based on trial and error, which was a tedious process because this search spanned many orders of magnitude before producing stable results. The value of s=10⁻¹² suggested in the prior art produced stable solver results. Smaller values also produced stable results, while larger values led to instability. Even though the solver results were stable in the sense that the Newton solver converged to finite values, no tuning configuration was found that avoided an input constraint violation under the conditions of Cases 2 and 3.

Adaptive SBMPC, an adaptive approach to nonlinear model predictive control, was applied in simulation to a combustion control problem from the literature. For comparison, the nonlinear dynamics of coal combustion within a commercial boiler were learned and controlled using Neural GPC as well as Adaptive SBMPC. SBMPO was demonstrated as an efficient nonlinear optimization, and was performed with close reference tracking achieved. Strengths of SBMPO, including computational speed, ease of tuning, and compatibility with any model, were demonstrated. The major strengths of the RBF network are the ability to modify the neural network structure during controller operation and the ability to learn plant behavior without the a priori specification of network size.

The original problem was extended to consider additional outputs and an additional control input as well as time-varying plant dynamics. Adaptive SBMPC was shown to be capable of rapid adjustments to changes in plant behavior and efficient nonlinear optimization for MIMO systems. With worst case execution times well under the ten-second sampling interval achieved for the combustion problem considered here, there is potential for real time implementation.

Comparison results were presented for a combustion system identification and control problem. The MIMO system was identified using BPN and RBF neural networks and the Adaptive SBMPC and Neural GPC control systems were used to perform NMPC. The results presented in Case 3 are the first control results of a time-varying MIMO plant using Neural GPC as well as the first control results for SBMPC implemented with the BPN neural network model. The results indicate that both neural network structures are capable of representing the nonlinear system and both control methodologies easily handle the SISO control case. When the MIMO problem was considered. Neural GPC tended to violate the input constraints, which led to poor reference tracking. By design, Adaptive SBMPC cannot violate input constraints and good tracking results were achieved using both the RBF and BPN neural network structures. Adaptive SBMPC generally achieved better computational times and in the worst case did not exceed the control period of 10 seconds.

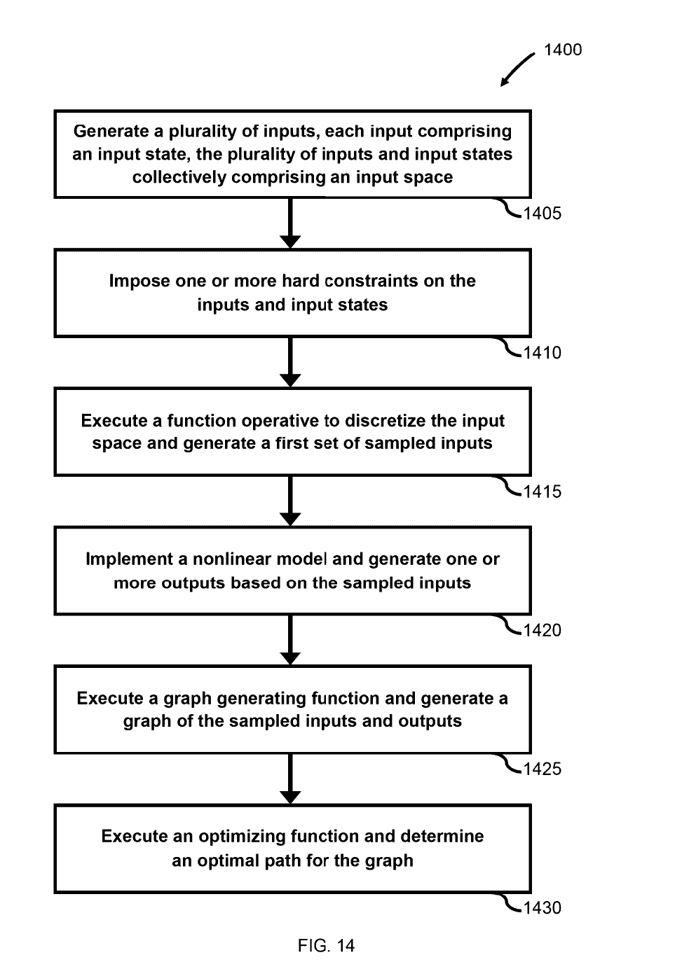

FIG. 14 illustrates a general flow diagram of various embodiments of a method 1400 for adaptive nonlinear model predictive control of multiple input, multiple output systems. At step 1405, a plurality of inputs may be generated. Each input may further comprise an input state, and the collection of inputs and input states may comprise an input space. One or more hard constraints may be imposed at step 1410 on the inputs and the inputs and input states. At step 1415, a function may be executed to discretize the input space and generate a first set of sampled inputs. A nonlinear model may be executed at step 1420. The nonlinear model may generate one or more outputs based on the sampled inputs. A graph generating function may be executed at step 1425 that generates a graph of the sampled inputs and outputs. At step 1430, an optimizing function may be executed to determine an optimal path for the graph.

In various embodiments of the method 1400, the graph generating function of step 1425 may comprise determining a node having a high probability of leading to a minimization solution to the nonlinear model. The node may be expanded to generate a first plurality of child nodes. One sampled input may be selected from the first set of sampled inputs and assigned to a child node, and this assignment may be carried out for each child node. A state may then be determined for each child node, and which child node has the highest probability of leading to a minimization solution to the nonlinear function may be determined. The high probability child node may be expanded to generate a second plurality of child nodes.

In various embodiments of the method 1400, the nonlinear model of step 1420 may be modified based on one or more of the outputs generated from the first set of sampled inputs. The function operative to discretize the input space may then be used to generate a second set of sampled inputs.

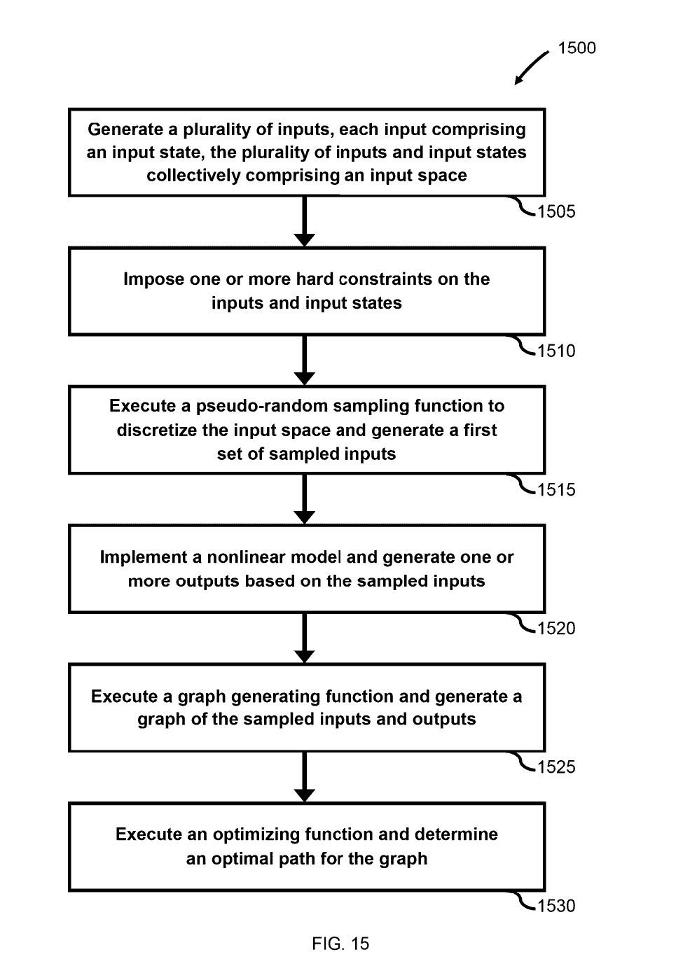

FIG. 15 illustrates a general flow diagram of various embodiments of a method 1500 for adaptive nonlinear model predictive control of multiple input, multiple output systems. At step 1505, a plurality of inputs may be generated. Each input may further comprise an input state, and the collection of inputs and input states may comprise an input space. One or more hard constraints may be imposed at step 1510 on the inputs and the inputs and input states. At step 1515, a pseudo-random sampling function may be executed to discretize the input space and generate a first set of sampled inputs. A nonlinear model may be executed at step 1520. The nonlinear model may generate one or more outputs based on the sampled inputs. A graph generating function may be executed at step 1525 that generates a graph of the sampled inputs and outputs. At step 1530, an optimizing function may be executed to determine an optimal path for the graph.

In various embodiments of the method 1500, the graph generating function of step 1525 may comprise determining a node having a high probability of leading to a minimization solution to the nonlinear model. The node may be expanded to generate a first plurality of child nodes. One sampled input may be selected from the first set of sampled inputs and assigned to a child node, and this assignment may be carried out for each child node. A state may then be determined for each child node, and which child node has the highest probability of leading to a minimization solution to the nonlinear function may be determined. The high probability child node may be expanded to generate a second plurality of child nodes.

In various embodiments of the method 1500, the nonlinear model of step 1520 may be modified based on one or more of the outputs generated from the first set of sampled inputs. The function operative to discretize the input space may then be used to generate a second set of sampled inputs.

Various embodiments may be stored or implemented on computer readable medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Programs embodied on a computer readable medium may be transmitted using any appropriate medium, including but not limited to wireless, wire-line, optical fiber cable, radio frequency, etc., or any suitable combination of the foregoing. Computer programs for carrying out operations for aspects of the present disclosure may be written in any combination of one or more programming languages, including an object oriented programming language such as Java, C#, C++ or the like and conventional procedural programming languages, such as the “C” programming language or similar programming languages.

Aspects of the present invention may be described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

### GLOSSARY OF CLAIM TERMS

LPA* (Lifelong Planning) optimization: A computer algorithm used for pathfinding and graph traversal that uses a best-first search combined with a heuristic to determine a least-cost path from a first node to one of a plurality of goal nodes. Even when the costs are allowed to change over time, the method produces an optimal path.

Child node: One or more nodes generated by an optimization algorithm after the most promising node has been found.

Discretize: The process of converting continuous attributes, features, or variables to discrete or nominal attributes, features, or variables.

Graph generating function: A function capable of producing a two-dimensional (or higher dimensional) plot of inputs and outputs to a model.

Hard constraint: Conditions for variable which must be satisfied.

Input: A value for a variable in a model.

Input space: The collection of all possible inputs to the model and the states of those inputs.

Input state: A minimum set of variables that fully describe the system and its response to any given set of inputs.

Minimal resource allocation network: A sequential learning algorithm for neural networks.

Model-based state prediction: Predictions of the state of a system used to minimize a cost function.

Node: a point in a network at which lines intersect, branch or terminate.

Nonlinear model: A mathematical representation of nonlinear relationships in experimental data.

Optimizing function: A process of optimizing a mathematical function with respect to some variables in the function while enforcing constraints on those variables.

Pseudo-random sampling: the generation of pseudo-random numbers that are distributed according to a given probability distribution.

Radial basis function neural network: a type of single-layer artificial neural network for application to problems of supervised learning.

Receding horizon: The process of shifting the prediction horizon further into the future with each iteration of a plant model.

What is claimed is:

1. A method for adaptive nonlinear model predictive control of multiple input, multiple output systems, comprising:
generating a plurality of inputs, each input further comprising an input state, the plurality of inputs and input states collectively comprising an input space;
imposing one or more hard constraints on the inputs and the input states;
executing a function operative to discretize the input space and generating a first set of sampled inputs;
implementing a nonlinear model and generating one or more outputs based on the sampled inputs;
executing a graph generating function and generating a graph of the sampled inputs and the outputs; and
executing an optimizing function and determining an optimal path for the graph.

2. The method of claim 1, wherein the function operative to discretize the input space comprises a pseudo-random sampling.

3. The method of claim 1, wherein the nonlinear model comprises a radial basis function neural network.

4. The method of claim 1, wherein the non-linear model comprises a minimal resource allocation network learning algorithm.

5. The method of claim 1, wherein the output generated by the non-linear model comprises model-based state predictions to minimize a cost function.

6. The method of claim 1, wherein the graph generating function further comprises:
determining a node having a high probability of leading to a minimization solution to the nonlinear model;
expanding the node to generate a first plurality of child nodes;
assigning one sampled input selected from the first set of sampled inputs to each child node;
determining a state for each child node;
determining which of the child nodes has the highest probability of leading to a minimization solution to the nonlinear function; and
expanding the high probability child node to generate a second plurality of child nodes.

7. The method of claim 1, wherein the optimization function further comprises a receding horizon.

8. The method of claim 1, further comprising modifying the nonlinear model based on one or more of the outputs generated from the first set of sampled inputs.

9. The method of claim 8, wherein the function operative to discretize the input space generates a second set of sampled inputs based on the modified nonlinear model.

10. The method of claim 1, wherein the optimizing function comprises LPA* optimization.

11. A method for adaptive nonlinear model predictive control of multiple input, multiple output systems, comprising:
generating a plurality of inputs, each input further comprising an input state, the plurality of inputs and input states collectively comprising an input space;
imposing one or more hard constraints on the inputs and the input states;
executing a pseudo-random sampling function to discretize the input space and generating a first set of sampled inputs;
implementing a nonlinear model and generating one or more outputs based on the sampled inputs;
executing a graph generating function and generating a graph of the sampled inputs and the outputs; and
executing an optimizing function and determining an optimal path for the graph.

12. The method of claim 11, wherein the non-linear model comprises a minimal resource allocation network learning algorithm.

13. The method of claim 11, wherein the output generated by the non-linear model comprises model-based state predictions to minimize a cost function.

14. The method of claim 11, wherein the graph generating function further comprises:
determining a node having a high probability of leading to a minimization solution to the nonlinear model,
expanding the node to generate a first plurality of child nodes;
assigning one sampled input selected from the first set of sampled inputs to each child node;
determining a state for each child node;
determining which of the child nodes has the highest probability of leading to a minimization solution to the nonlinear function; and
expanding the high probability child node to generate a second plurality of child nodes.

15. The method of claim 11, further comprising modifying the nonlinear model based on one or more of the outputs generated from the first set of sampled inputs.

16. The method of claim 15, wherein the function operative to discretize the input space generates a second set of sampled inputs based on the modified nonlinear model.

17. A non-transitory computer readable medium containing computer program instructions, which when executed by one or more processors causes a device to:
generating a plurality of inputs, each input further comprising an input state, the plurality of inputs and input states collectively comprising an input space;
imposing one or more hard constraints on the inputs and the input states;
executing a pseudo-random sampling function to discretize the input space and generating a first set of sampled inputs;
implementing a nonlinear model and generating one or more outputs based on the sampled inputs;
executing a graph generating function and generating a graph of the sampled inputs and the outputs; and
executing an optimizing function and determining an optimal path for the graph.

18. The non-transitory computer readable medium of claim 17, wherein the graph generating function further comprises:
determining a node having a high probability of leading to a minimization solution to the nonlinear model;
expanding the node to generate a first plurality of child nodes;
assigning one sampled input selected from the first set of sampled inputs to each child node;
determining a state for each child node;
determining which of the child nodes has the highest probability of leading to a minimization solution to the nonlinear function; and
expanding the high probability child node to generate a second plurality of child nodes.

19. The non-transitory computer medium of claim 17, further comprising modifying the nonlinear model based on one or more of the outputs generated from the first set of sampled inputs.

20. The non-transitory computer medium of claim 19, wherein the function operative to discretize the input space generates a second set of sampled inputs based on the modified nonlinear model.
